(19) United States
(12) Patent Application Publication
(10) Pub. No.: US 2014/0277918 A1
(43) Pub. Date: Sep. 18, 2014

(54) METHOD FOR PROCESSING DATA AND AN ELECTRONIC DEVICE THEREOF

(71) Applicant: Samsung Electronics Co., Ltd., Gyeonggi-do (KR)

(72) Inventor: Sang-Don KIM, Gyeonggi-do (KR)

(73) Assignee: Samsung Electronics Co., Ltd., Gyeonggi-do (KR)

(21) Appl. No.: 14/208,721

(22) Filed: Mar. 13, 2014

(30) Foreign Application Priority Data
Mar. 13, 2013 (KR) 10-2013-0026872

(51) Int. Cl. G07C 5/00

(52) U.S. Cl. CPC G07C 5/008
USPC 701/31.5

(57) ABSTRACT

A method and apparatus for processing vehicle driving data in an electronic device are provided. The method includes receiving driving data, corresponding to a vehicle, from a driving data acquiring device; transmitting the driving data to a server; and receiving standard driving data, which is obtained by standardizing the driving data, from the server, wherein the standard driving data is compared with second standard driving data, other vehicle driving data, or other vehicle standard driving data.

### PRIORITY

This application claims priority under 35 U.S.C. §119 to an application filed in the Korean Intellectual Property Office on Mar. 13, 2013 and assigned Serial No. 10-2013-26872, the contents of which are incorporated herein by reference.

### BACKGROUND OF THE INVENTION

1. Field of the Invention

The present invention relates generally to a data processing method and an electronic device thereof.

2. Description of the Related Art

With the development of mobile communication technology, electronic devices are presently being used as personal essential communication devices. In addition, electronic devices are evolving into multimedia devices that provide various services or functions, such as voice communication, camera functions, data communication, broadcast functions, video play, audio play, messaging functions, schedule management, and alarm functions.

Presently, an electronic device may check a state of a vehicle through an On-Board Diagnosis (OBD) device equipped in the vehicle. For example, through the OBD device of the vehicle, the electronic device may check vehicle driving state information, such as speed, driving time, revolutions per minute (RPM), driving distance, average mileage, and instantaneous mileage, engine state information, such as engine RPM, coolant temperature, intake air temperature, intake air amount, engine oil temperature, transmission oil temperature, fuel injection amount, oxygen sensor voltage, ignition angle, carbon discharge amount, air-to-fuel ratio learning value, and vehicle state information, such as brake state, battery voltage, and air conditioner refrigerant pressure.

When a problem arises in the vehicle, the electronic device may check information about the problem in the vehicle through data collected by the OBD device.

### SUMMARY OF THE INVENTION

The present invention has been made to address at least the above problems and/or disadvantages and to provide at least the advantages described below.

Accordingly, an object of the present invention is to provide an electronic device that receives OBD data from an OBD device or a second electronic device, standardizes the OBD data, and constructs a database thereof, thereby increasing data utilization.

Another object of the present invention is to provide an electronic device that receives OBD data from an OBD device, transmits the OBD data to a server without displaying the OBD data, and allows the server to standardize the OBD data, thereby increasing data utilization.

Another object of the present invention is to provide an electronic device that receives and displays standard OBD data from a server at the request of a user, thereby increasing data utilization by the user.

Another object of the present invention is to provide an electronic device that displays information about vehicles of a user, thereby enabling efficient management of the vehicles.

According to an aspect of the present invention, a method for processing data in an electronic device is provided. The method includes receiving driving data, corresponding to a vehicle, from a driving data acquiring device; transmitting the driving data to a server; and receiving standard driving data, which is obtained by standardizing the driving data, from the server, wherein the standard driving data is compared with second standard driving data, other vehicle driving data, or other vehicle standard driving data.

According to another aspect of the present invention, a method for processing data in an electronic device is provided. The method includes receiving driving data, corresponding to a vehicle, from a driving data acquiring device or a second electronic device; generating standard driving data using the driving data; constructing a database of the driving data or the standard driving data by the electronic device; and transmitting the standard driving data to the second electronic device in response to a request by the second electronic device.

According to another aspect of the present invention, an electronic device is provided. The electronic device includes at least one processor; at least one communication system configured to communicate with a driving data acquiring device or a server; at least one memory unit; and at least one program stored in the at least one memory unit and executed by the at least one processor, wherein the at least one program includes instructions for: receiving driving data, corresponding to a vehicle, from the driving data acquiring device; transmitting the driving data to the server; receiving standard driving data, which is obtained by standardizing the driving data, from the server; and displaying information regarding the standard driving data.

According to another aspect of the present invention, an electronic device is provided. The electronic device includes at least one processor; at least one communication system configured to communicate with a driving data acquiring device or a second electronic device; at least one memory unit; and at least one program stored in the at least one memory unit and executed by the at least one processor, wherein the at least one program includes instructions for: receiving driving data, corresponding to a vehicle, from the driving data acquiring device or the second electronic device; generating standard driving data using the driving data; constructing a database of the driving data or the standard driving data by the electronic device; and transmitting the standard driving data to the second electronic device in response to a request by the second electronic device.

According to another aspect of the present invention, a method for processing data in an electronic device is provided. The method includes receiving driving data, corresponding to a vehicle, from a driving data acquiring device or a second electronic device; generating standard driving data using the driving data; constructing a database of the driving data or the standard driving data by the electronic device; displaying information regarding the standard driving data included in the database; and transmitting the standard driving data to the second electronic device in response to a request by the second electronic device, wherein the standard driving data is compared with second standard driving data, other vehicle driving data, or other vehicle standard driving data.

### BRIEF DESCRIPTION OF THE DRAWINGS

The above and other objects, features and advantages of the present invention will become more apparent from the following detailed description when taken in conjunction with the accompanying drawings in which:

FIG. 1A is a diagram illustrating an operation of an electronic device according to an embodiment of the present invention;

FIG. 1B is a diagram illustrating an operation of an electronic device according to an embodiment of the present invention;

FIG. 1C is a diagram illustrating an operation of an electronic device according to an embodiment of the present invention;

FIG. 2 is a diagram illustrating a block configuration of an electronic device according to an embodiment of the present invention;

FIG. 3A is a diagram illustrating a User Interface (UI) operation displayed on a display unit of an electronic device according to an embodiment of the present invention;

FIG. 3B is a diagram illustrating a UI operation displayed on a display unit of an electronic device according to an embodiment of the present invention;

FIG. 3C is a diagram illustrating a UI operation displayed on a display unit of an electronic device according to an embodiment of the present invention;

FIG. 3D is a diagram illustrating a UI operation displayed on a display unit of an electronic device according to an embodiment of the present invention;

FIG. 3E is a diagram illustrating a UI operation displayed on a display unit of an electronic device according to an embodiment of the present invention;

FIG. 4A is a diagram illustrating a program operation in an electronic device according to an embodiment of the present invention; and

FIG. 4B is a diagram illustrating a program operation in an electronic device according to an embodiment of the present invention.

### DETAILED DESCRIPTION OF EMBODIMENTS OF THE PRESENT INVENTION

Embodiments of the present invention will be described herein with reference to the accompanying drawings. In the following description, detailed descriptions of well-known functions or configurations will be omitted since they would unnecessarily obscure the subject matter of the present invention. Also, the terms used herein are defined according to the functions of the present invention. Thus, the terms may vary depending on users' or operators' intentions or practices. Therefore, the terms used herein should be understood based on the descriptions made herein.

In the description of the embodiments of the present invention, an electronic device may include a touchscreen that performs an input operation through an input device and a display operation through a display unit on one physical screen.

The present invention is not limited to an electronic device including a touchscreen, and may instead be applied to various electronic devices in which a display unit and an input device are physically divided from each other, or which includes only one of a display unit and an input device.

In the following description, an electronic device 100 may include, for example, a mobile terminal, a Personal Digital Assistant (PDA), a laptop computer, a smart phone, a smart Television (TV), a netbook, a Mobile Internet Device (MID), an Ultra Mobile Personal Computer (UMPC), a tablet PC, a mobile pad, a media player, a hand-held computer, a navigation device, an MPEG-1 Audio Layer-3 Player (MP3P), and a server.

It will be understood that when an element or component is referred to as being “connected” or “coupled” to another element or component, it may be directly connected or coupled to the other element or component or intervening elements or components may be present between the connected or coupled elements. On the other hand, when an element or component is referred to as being “directly connected” or “directly coupled” to another element or component, there are no intervening elements or components present between the directly connected or directly coupled elements.

FIG. 1A illustrates an operation of an electronic device according to an embodiment of the present invention.

Referring to FIG. 1A, an electronic device 100 receives On-Board Diagnosis (OBD) data measured by an OBD device 201 of a vehicle #1, transmits the OBD data to a server 203, accesses the server 203 to receive standard OBD data of a database, and displays the standard OBD data.

Herein, an output on the electronic device 100 may be displayed on a second display unit or a touchscreen 133 of the electronic device 100, or may use an audio output method such as a voice or a signal sound using a speaker.

The OBD 201 of FIG. 1A may be an OBD device of a vehicle. OBD #1 205 and OBD #2 207 of FIG. 1B and OBD #3 209 of FIG. 1C may be an OBD device 205 of a vehicle #1, an OBD device 207 of a vehicle #2, and an OBD device 209 of a vehicle #3, respectively. Also, in the following description, the OBD device 205 of the vehicle #1, the OBD device 207 of the vehicle #2, and the OBD device 209 of the vehicle #3 may be referred to as an OBD device #1 205, an OBD device #2 207, and an OBD device #3 209, respectively, for easy discrimination therebetween, and may collectively be referred to as an OBD device 201 when discrimination therebetween is not necessary in the description.

OBD data used by the OBD device 201 may be configured by using at least one of various protocols used by the OBD device 201, such as Controller Area Network (CAN) and Pulse Width Modulation (PWM), and may include a vehicle IDentification (ID) code and a parameter ID code. The ID code may be included in a data header.

For example, the OBD device 201 of the vehicle #1 may be a Korean OBD (KOBD) device 201 that provides a service corresponding to the KOBD standard, and an OBD check program 114 of the electronic device 100 may be an OBD Version II (OBD-2) check program 114 that provides a service corresponding to the OBD-2 standard. (FIG. 2)

Herein, the KOBD standard is a derivative standard of the OBD-2 standard, and provides a service corresponding to the OBD-2 standard and may further provide an extended service.

Therefore, standard KOBD data acquired by the KOBD device 201 may be transmitted to the electronic device 100, and the OBD-2 check program 114 of the electronic device 100 may fail to display some information corresponding to an unappointed instruction or an unappointed User Interface (UI) environment, among information of the standard KOBD data.

An OBD viewer displayed on a display unit 131 (FIGS. 3A-3E) of the electronic device 100 of FIGS. 1A to 1C enables the information of OBD data or standard OBD data to be displayed.

The electronic device 100 may receive KOBD data from the KOBD device 201 and transmit the KOBD data to the server 203 through a communication system 150. (FIG. 2)

The server 203 analyzes the KOBD data, parses the same according to a standard format, and constructs a database thereof. Also, the predetermined or standard format may use an instruction or a UI environment associated with the electronic device 100 or the OBD-2 check program 114 of the electronic device 100, and may be a generally-used document format or a data format.

The electronic device 100 displays information regarding standard data received from a database (not illustrated) of the server 203.

Accordingly, the electronic device 100 receives standard KOBD data of the vehicle #1 from the server 203, and displays information regarding the KOBD data, which may fail to be displayed by the OBD-2 check program 114, using the standard KOBD data.

Herein, the standard KOBD data refers to an original OBD standard in the embodiments of the present invention, and the standard KOBD data, standard European OBD (EOBD) data, standard OBD-1 data, or standard OBD-2 data may include data that has the same format as the standard OBD data.

In FIG. 1A, the OBD standard of the OBD device 201 includes not only the above-described KOBD but also OBD version I (OBD-1), OBD-2, or EOBD, and the OBD standard used by the OBD check program 114 of the electronic device 100 includes not only the above-described OBD-2 but also OBD-1, EOBD, or KOBD.

In an embodiment of the present invention, the OBD device 201 is a KOBD device 201 that uses the KOBD standard, and the OBD check program 114 of the electronic device 100 is a KOBD check program 114 that uses the KOBD standard. The electronic device 100 may receive standard KOBD data from the KOBD device 201 and use an instruction or a UI environment associated with the KOBD check program 114 of the electronic device 100, and thus may display information of the KOBD data.

Also, the electronic device 100 transmits the KOBD data to the server 203 through the communication system 150. The server 203 may construct a database (not illustrated) of the KOBD data received from the electronic device 100, according to a standard format using an instruction or a UI environment associated with the KOBD check program 114 of the electronic device 100.

The electronic device 100 receives standard KOBD data of the vehicle #1 from the server 203 and uses an instruction or a UI environment associated with the KOBD check program 114 of the electronic device 100, and thus may display information of the standard KOBD data.

FIG. 1B illustrates an operation of an electronic device according to an embodiment of the present invention.

Referring to FIG. 1B, in addition to the embodiment of FIG. 1A, the OBD device #2 201 of the vehicle #2 transmits measured OBD data #2 to the server 203, and the electronic device 100 accesses the server 203 to receive standard OBD data #2 from a database (not illustrated), and displays the standard OBD data #2.

For example, the OBD device #1 205 of the vehicle #1 may be an EOBD device 205 that provides a service corresponding to the EOBD standard, and the OBD check program 114 of the electronic device 100 may be an OBD-2 check program 114 that provides a service corresponding to the OBD-2 standard.

Herein, the EOBD standard is a derivative standard of the OBD-2 standard, which is introduced according to European Directive 98/69/EC, and may provide some of the services corresponding to the OBD-2 standard.

Therefore, the EOBD device 205 transmits acquired standard EOBD data to the electronic device 100, and the OBD-2 check program 114 of the electronic device 100 may fail to display some information corresponding to an unappointed instruction or an unappointed UI environment, among information of the standard EOBD data.

The electronic device 100 receives EOBD data from the EOBD device 205 and transmits the EOBD data to the server 203 through the communication system 150.

The OBD device #2 207 of the vehicle #2 may be a KOBD device 207 that provides a service corresponding to the KOBD standard. The KOBD device 207 transmits acquired standard KOBD data to the server 203.

The server 203 analyzes the EOBD data or KOBD data, parses the same according to a standard format, and constructs a database thereof. Also, the standard format may use an instruction or a UI environment associated with the OBD-2 check program 114 of the electronic device 100, and the electronic device 100 may display information regarding the standard data received from the database.

Therefore, the electronic device 100 receives standard EOBD data of the vehicle #1 or standard KOBD data of the vehicle #2 from the server 203, and displays information of the EOBD data or the KOBD data, which may fail to be displayed by the OBD-2 check program 114 of the electronic device 100, by using the standard EOBD data or the standard KOBD data.

FIG. 1C illustrates an operation of an electronic device according to an embodiment of the present invention.

Referring to FIG. 1C, an electronic device 100 receives OBD data #1 measured by an OBD device #1 205 of a vehicle #1, OBD data #2 measured by an OBD device #2 207 of a vehicle #2, and OBD data #3 measured by an OBD device #3 209 of a vehicle #3, analyzes the received data, constructs a database thereof, and displays the same.

For example, the OBD device #1 205 of the vehicle #1 may be an OBD-1 device 205 that provides a service corresponding to the OBD-1 standard, the OBD device #2 207 of the vehicle #2 may be an EOBD device 207 that provides a service corresponding to the EOBD standard, the OBD device #3 209 of the vehicle #3 may be a KOBD device 209 that provides a service corresponding to the KOBD standard, and the OBD check program 114 of the electronic device 100 may be an OBD-2 check program 114 that provides a service corresponding to the OBD-2 standard.

Herein, the OBD-2 standard is a derivative standard of the OBD-1 standard, and provides a service corresponding to the OBD-1 standard and may further provide an extended service.

Therefore, the OBD-1 device 205 of the vehicle #1 transmits acquired standard OBD-1 data to the electronic device 100, and the OBD-2 check program 114 of the electronic device 100 includes and displays an appointed program language or an appointed UI environment that may display information regarding the received OBD-1 data.

The EOBD device 207 of the vehicle #2 transmits acquired standard EOBD data to the electronic device 100, and the OBD-2 check program 114 of the electronic device 100 may fail to display some information corresponding to an unappointed instruction or an unappointed UI environment, among information of the standard EOBD data.

The KOBD device 209 of the vehicle #3 transmits acquired standard KOBD data to the electronic device 100, and the OBD-2 check program 114 of the electronic device 100 may fail to display some information corresponding to an unappointed instruction or an unappointed UI environment, among information of the standard KOBD data.

The electronic device 100 uses a database program (not illustrated) to analyze the OBD-1 data, the EOBD data, and KOBD data, parse the same according to a standard format, and construct a database thereof. Also, the standard format may use an instruction or a UI environment associated with the OBD-2 check program 114 of the electronic device 100, and the electronic device 100 may display information regarding the OBD-1 data, the EOBD data, and the KOBD data, which may not be displayed by the OBD-2 check program 114, by using the standard OBD-1 data, the standard EOBD data, or the standard KOBD data.

FIG. 2 illustrates a block configuration of an electronic device according to an embodiment of the present invention.

As illustrated in FIG. 2, an electronic device 100 includes a memory unit 110, a processor unit 120, an input/output (I/O) processing unit 130, a display unit 131, an input device 132, an audio processing unit 140, a communication system 150, and other peripheral devices.

The memory unit 110 includes a program storage unit 111 for storing a program for controlling an operation of the electronic device 100, and a data storage unit 112 for storing data generated during the execution of a program, and may store data generated in a program by an operation of a processor 122.

For example, the data storage unit 112 stores OBD data received from the OBD device, data generated during the construction of a database by using a database program (not illustrated), or standard OBD data received from the server 203.

The program storage unit 111 includes at least one application program 113, the OBD check program 114, a service state check program 115, a UI program 116, a communication control program 117, and an I/O control program (not shown). Herein, a program included in the program storage unit 111 may be referred to as an instruction set including a set of instructions.

Although not illustrated, the database program (not illustrated) may use OBD data to generate standard OBD data and construct a database thereof.

For example, the database program may analyze and parse OBD data to generate standard OBD data according to a predetermined format, and may use the standard OBD data to construct a database thereof.

The analysis classifies standard OBD information acquired by the OBD device 201 according to predetermined conditions or items, and obtains new information using the standard OBD information. For example, information, such as a fuel consumption per piston movement of a vehicle engine cylinder #1 and an RPM of an engine crankshaft, may be used to obtain information such as a vehicle mileage (for example, a driving distance per 1 L of fuel).

The parsing generates standard data according to a predetermined format by using the standard OBD information acquired by the OBD device 201.

For example, the KOBD standard may include engine oil temperature information, the OBD-2 standard may not include engine oil temperature information, and both the KOBD standard and the OBD-2 standard may include carbon emission amount information. The database program (not illustrated) may construct standard OBD data including information about an engine oil temperature value or a carbon emission amount according to a predetermined format by using a program language or a UI environment associated with the OBD check program 114.

When an OBD-2 check program is used to display information regarding KOBD data, carbon emission amount information included in the OBD-2 standard may be displayed, but engine oil temperature information not included in the OBD-2 standard may not be displayed. However, when standard OBD data is used, the OBD-2 check program may also display engine oil temperature information not included in the OBD-2 standard.

The above-described analysis and parsing is merely a description of an embodiment, and may not necessarily be used discriminatively. Therefore, the content of the analysis may be used in the parsing process, the content of the parsing may be used in the analysis process, and other methods may be used in the above-described analysis or parsing process. Also, an identification code, such as, Parameter IDentification (PID), may be used in the above-described analysis, parsing, or standard OBD data generation.

Also, the database program may be included in the OBD device to generate standard OBD data, or may be included in the server, the electronic device 100, or the OBD check program 114.

Also, the database program may use a program language or a protocol capable of processing various OBD standards, such as, for example, OBD-1, OBD-2, KOBD, and EOBD, to process nonstandard OBD data, and may use an appointed UI environment, an appointed program language, generally-used various document formats, or various data formats to generate standard OBD data, construct a database, or transmit to and display in a second electronic device.

The OBD check program 114 may display information corresponding to an appointed program language or an appointed UI environment, among the OBD data measured by the OBD device, and may display information of the standard OBD data.

For example, the OBD-1 device may acquire only information about an engine state, and the OBD-2 device may acquire at least two-stage segments of information about an engine state. When the OBD-1 check program of the electronic device 100 is used to display information of OBD-2 data, the OBD-1 check program may use the OBD-2 data to display only information about an engine state appointed in the OBD-1 standard, or may fail to display at least two-stage segments of information about an engine stage appointed in the OBD-2 standard, which may cause an error. Also, the OBD-1 check program may analyze or parse the OBD-2 data to display information regarding the OBD-2 data.

As another example, the OBD check program 114 may use standard OBD data to display information regarding standard OBD data regardless of the OBD standard used by the OBD check program. The standard OBD data may be generated by the database program (not illustrated) using an appointed program language or an appointed UI environment associated with the OBD check program 114.

Also, the standard OBD data may be displayed by using not only the OBD check program 114 but also a generally-used OBD data display program or a display program configured by an appointed program language or an appointed UI environment associated with the database program.

A service state check program 115 may include at least one software component for checking a state of a service provided by the elements or the program of the electronic device 100.

The UI program 116 may include at least one instruction or software element for providing a user interface in the electronic device 100.

For example, the electronic device 100 may construct a UI operation of standard OBD data according to a UI environment used in the OBD check program 114, and display the same on the touchscreen 133 or a second display unit.

The I/O control program may display an operation of the electronic device 100 on the display unit 131, and receive an input of an operation command of the electronic device 100 through the input device 132.

The communication control program 117 may include at least one software element for controlling communication with at least one second electronic device through the communication system 150. For example, the communication control program 117 searches for a second electronic device with which to establish communication. When a second electronic device for communication connection is found, the communication control program 117 establishes a connection for communication with the second electronic device. Thereafter, the communication control program 117 performs a performance search and session establishment process with the second electronic device to communicate data, such as alarm information, with the second electronic device through the communication system 150.

The application program 113 may include a software element for executing at least one application program installed in the memory unit 110 of the electronic device 100.

One or more memory units 110 may be included in the electronic device 100. Also, according to certain embodiments, the memory unit 110 may function as only one or both of the program storage unit 111 and the data storage unit 112, and a physical region division inside the memory unit 110 may be indefinite.

The processor unit 120 includes a memory interface 121, at least one processor 122, and a peripheral interface 123. Herein, the memory interface 121, the processor 122, and the peripheral interface 123 included in the processor unit 120 may be integrated into at least one integrated circuit or may be implemented as separate elements.

The memory interface 121 controls the access to the memory unit 110 by an element such as the processor 122 or the peripheral interface 123.

The peripheral interface 123 controls the connection between the processor 122 and the memory interface 121 and a peripheral I/O device of the electronic device 100.

The processor 122 uses at least one software program to perform control such that the electronic device 100 provides various services, such as multimedia and communication services, and displays an operation of the electronic device on the display unit 131 through the I/O processing unit 130, and an input device 132 receives an input of a command from the outside of the electronic device 100. In this case, the processor 122 may execute at least one program stored in the memory unit 110 to provide a service corresponding to the program.

The audio processing unit 140 provides an audio interface between a user and the electronic device 100 through a speaker 141 and a microphone 142.

The communication system 150 performs communication functions. For example, the communication system 150 communicates with the second electronic device by using at least one of mobile communication through a base station, near-field communication, such as Infrared Data Association (IrDA), Bluetooth, or Wireless Fidelity (Wi-Fi), wireless LAN communication, and wired communication.

The I/O processing unit 130 provides an interface between the peripheral interface 123 and I/O devices such as the display unit 131 and the input device 132.

The input device 132 provides input data, generated by user selection, to the processor unit 120 through the I/O processing unit 130.

For example, the input device 132 may include only a control button or a keypad in order to receive control data from the outside of the electronic device 100.

As another example, the input device 132 may be included in the display unit 132 like the touchscreen 133. In this case, the input device 132 of the touchscreen 133 may use a capacitive method, a resistive film (pressure sensing) method, an infrared method, an electromagnetic induction method, or an ultrasonic method to detect a touch.

The display unit 131 receives display status information of the electronic device 100, characters and moving or still pictures (hereinafter referred to as images), which are input from the outside, from the processor unit 120, constructs a UI operation, and displays the same through an I/O control unit.

A touchscreen 133 is a combination of the display unit 131 and the input device 132. The touchscreen 133 may be configured to input a command by touching a screen configuration displayed on the display unit 131 in an operation of the electronic device 100.

Thus, the touchscreen 133 may function as both the display unit 131 for displaying a UI operation of the electronic device 100 and the input device 132 for inputting an external command to the electronic device 100. Therefore, in the following description, the display unit 131 of the touchscreen 133 and the input device 132 of the touchscreen 133 may collectively be referred to as the touchscreen 133.

The audio processing unit 140 is connected to a speaker 141 and a microphone 142 to perform an audio input and output such as voice recognition, voice duplication, digital recording, and communication functions. That is, the audio processing unit 140 provides communication between users through the speaker 141 and the microphone 142. Further, the audio processing unit 140 receives a data signal from other device, converts the received data signal to an electric signal, and outputs the converted electric signal through the speaker 141.

The speaker 141 converts and outputs an electric signal to an audible frequency band, is disposed at the rear side of the electronic device 100, and includes a flexible film speaker in which at least one piezoelectric body is attached to one vibration film.

The microphone 142 converts a sound wave transferred from a person or other sound sources to an electric signal. Further, the audio device 160 receives an electric signal from the microphone 142, converts the received electric signal to an audio data signal, and transmits the converted audio data signal to other device. The audio device 160 may include an earphone, a headphone, and a head set that may be attached to the electronic device 100 and that may be detached from the electronic device 100.

FIG. 3A illustrates a UI operation displayed on a display unit of an electronic device according to an embodiment of the present invention.

Referring to FIG. 3A, the OBD check program 114 of the electronic device 100 displays a list of standard data and may display an abnormal state of a vehicle in standard OBD data.

For example, the electronic device 100 may receive standard OBD data from the server 203. Herein, the electronic device 100 may receive standard OBD data corresponding to two or more vehicles by using identification codes including an identification code of the electronic device 100 and an identification code of the second electronic device. The electronic device 100 may display a list of standard OBD data included in the memory unit 110 using the OBD check program. Also, the electronic device 100 may process standard OBD data, compare various parameters of information included in the standard OBD data, and display a result thereof.

A list of standard OBD data of the vehicle #2 in an entire period (All) of 2013, among the standard OBD data included in the memory unit 110 of the electronic device 100, may be displayed by selecting a “Data” tab 309, a “Vehicle #2” label in a first drop down menu 311 (which may have the same function as “301” of FIG. 3B), a “2013” label in a second drop down menu 313, and an “All” label in a third drop down menu 315 in the OBD check program 114 displayed on the touchscreen 133 of the electronic device 100.

In the “Data” tab 309, in the list of standard OBD data included in the memory unit 110, when abnormal data or data to be checked is included in the vehicle information included in the standard OBD data, the data may be represented by a mark (“345” or “347”). Referring to FIG. 3A, when standard “20130221” OBD data 343 measured on Feb. 21, 2013 includes a value corresponding to an abnormal state, the mark 345 corresponding to an abnormal state may be displayed. When the standard “20130221” OBD data 343 includes a value corresponding to a state to be checked, the mark 347 corresponding to a check-necessity state may be displayed.

Referring to FIG. 3A and FIG. 3E, like a transmission state of the vehicle #1, when some of the values of the transmission of standard OBD data is included in a range value indicating abnormality, corresponding OBD data (illustrated as the standard “20130221” OBD data 343 of FIG. 3A) may be displayed with the mark 345 representing an abnormal state. If a “Detail” (321, 323, 325) tab is touched, details of the relevant data may be displayed like FIG. 3B.

As another example, such as a coolant state of the vehicle #1 and a transmission state of the vehicle #3, when some of the values of the coolant state or the transmission state of standard OBD data is included in a range value indicating check necessity, corresponding OBD data (illustrated as the standard “20130217” OBD data 349 of FIG. 3A) may be displayed with the mark 347 representing a check-necessity state.

Vehicle states, such as the abnormal state 345 and the check-necessity state 347, may be determined according to a range defined in the OBD check program, by comparison with data provided by a vehicle manufacturer, through a Diagnostic Trouble Code (DTC), or by using OBD data.

The data indication the “abnormality” (345) or “check necessity” (347) may be checked by selecting (i.e., touching) a “Detail” tab 303. For example, when the “abnormality” (343) mark of the standard “20130221” OBD data 343 and “Detail” tab 303 are touched simultaneously or subsequently, some of the measurement values of abnormal data of vehicle 1 may be displayed as illustrated in FIG. 3B. Relevant data 20130221 may be displayed in “304”.

When a “Comparison” tab 305 is selected, values of the standard OBD data corresponding to a predetermined comparison target and the vehicle #2 may be checked. The predetermined comparison target may be an average corresponding to the same vehicle model of a database (not illustrated), may be data provided by a vehicle manufacturer, or may be standard OBD data of other vehicles included in the memory unit 110.

Also, in FIG. 3A, when data (for example, 341) without the mark (345, 347) is selected, and the “Detail” tab 303 is touched simultaneously or subsequently, the standard OBD data may be displayed.

FIG. 3B illustrates a UI operation displayed on a display unit of an electronic device according to an embodiment of the present invention.

Referring to FIG. 3B, the OBD check program 114 of the electronic device 100 may display information about a vehicle state according to a UI environment of the OBD check program 114 by using standard OBD data or OBD data measured by the OBD device of a vehicle.

For example, in the “Detail” tab 303, the electronic device 100 may acquire detailed data corresponding to selected detailed items from the standard OBD data and display the same.

For example, referring to FIG. 3B, an item related to an engine temperature, among the standard OBD data included in the memory unit 110 of the electronic device 100 and the standard OBD data of Vehicle #1, Jan. 3, 2013, may be displayed in a graph by selecting “Engine Temperature” from a drop down menu 310 in, “Vehicle #1” in a drop down menu 301, “View in Graph” in “302”, and a date (not illustrated).

Referring to the drop down menu 301, it may be seen that engine state information displayed on the touchscreen 133 is information acquired from the standard OBD data of the vehicle #1. When the drop down menu 301 includes standard OBD data about vehicles other than the vehicle #1, it may provide a menu capable of displaying information about the vehicle (for example, representing “Vehicle #2”, “Vehicle #3”, and “Overall” as options).

Referring to the drop down menu 310, it may be seen that information displayed on the touchscreen 133 is information about an engine temperature of the standard OBD data. The drop down menu 310 may provide a menu including items capable of being acquired from the OBD data in addition to the engine temperature (for example, representing “Mileage”, “Transmission”, and “Engine Oil” as options).

Referring to “302”, when values corresponding to information of the standard OBD data or the OBD data may be displayed in a graph or a chart (table), it is possible to provide a menu 302 with options, including, for example, “View in Graph” or “View in Chart”. Referring to FIG. 3B, when “View in Graph” is selected, items related to the engine temperature, such as an air flow, an air flow rate, an engine voltage, and a coolant temperature, may be displayed.

FIG. 3C illustrates a UI operation displayed on a display unit of an electronic device according to an embodiment of the present invention.

By selecting detailed items in the “Detail” tab 303 of the OBD check program 114 of the electronic device 100, standard OBD data selected from the standard OBD data and information about the detailed items may be obtained and displayed.

For example, referring to FIG. 3C, mileage-related information among the standard OBD data of vehicles (vehicle #1, vehicle #2, and vehicle #3) included in the memory unit 110 of the electronic device 100 may be displayed on a monthly basis in a graph for an entire period by selecting “Mileage” in the drop down menu 310, “Overall” in the drop down menu 301, “Monthly” in a drop down menu 331, “All Period” in a drop down menu 333, and “View in Graph” in 302.

By selecting one of a plurality of monthly periods, the graph may display a mileage change in the vehicles for the period and display average mileages 335, 337 and 339. In the drop down menu 331, a menu capable of selecting a monthly, daily or yearly display period may be provided, and a mileage change in the vehicles may be displayed monthly, daily or yearly according to an option. In the drop down menu 333, a menu capable of selecting a driving state, such as high constant speed driving, low constant speed driving, congested driving, and all period, may be provided, and a mileage change in the vehicles about the driving state may be displayed in an option.

The electronic device 100 may acquire information corresponding to an intake air temperature, an average molecular weight of air, a fuel constant, volumetric efficiency, an engine exhaust amount, an engine RPM, a fuel injection amount, and a fuel injection time from the standard OBD data by an identification code such as a PID code, and may obtain a mileage by using at least two pieces of information.

In the drop down menu 310, in addition to the mileage, various parameters for checking the vehicle state, such as oil, transmission, and engine temperatures, may be provided. Information about the various parameters may be included in the standard OBD data which may be acquired by an identification code such as a PID code may also provided.

FIG. 3D illustrates a UI operation displayed on a display unit of an electronic device according to an embodiment of the present invention.

Referring to FIG. 3D, the electronic device 100 compares various parameters by using the standard OBD data included in the database.

For example, referring to a drop down menu 361 of the “Comparison” tab 305, mileages among the various parameters included in the standard OBD data may be compared.

Referring to Vehicle #1, Vehicle #2 and Vehicle #3 items, the mileages may be divided into detailed items such as high constant speed, low constant speed, and congested driving. The detailed items may be acquired or obtained from the standard OBD data by an identification code such as a PID code corresponding to a value necessary to obtain detailed items such as a driving speed determining a high speed or a low speed, an engine RPM, a constant-speed time, and a constant-speed driving distance.

Referring to Vehicle #1, item 363 may represent a comparison group A vehicle of the vehicle #1, obtain data corresponding to the high constant speed, low constant speed driving, and congested driving from the standard OBD data of the A vehicle, and represent the same.

Item 365 may represent the vehicle #1, obtain data corresponding to the high constant speed, low constant speed driving, and congested driving from the standard OBD data of the vehicle #1, and represent the same.

A vehicle #2 and a comparison group B vehicle of a vehicle #2 item and a vehicle #3 and a comparison group C vehicle of a vehicle #3 item may also be obtained in the same manner as items 363 and 365.

Mileage information corresponding to the A vehicle, the B vehicle, and the C vehicle may be information obtained from the standard OBD data provided by the vehicle manufacturer, information obtained from the standard OBD data of other vehicles included in the database, and/or information obtained by averaging the standard OBD data of the same vehicle model included in the database.

Also, detailed items such as the vehicle #1, the vehicle #2, and the vehicle #3 may be recommended according to a driving state by using data such as high constant speed, low constant speed, and congested driving. Referring to item 367, the vehicle #3 having the highest mileage in congested driving may be recommended in a city-driving state corresponding to a congested-driving state, and the vehicle #2 having the highest mileage in high constant speed driving may be recommended in a high speed driving state corresponding to a high constant speed driving state.

The electronic device 100 may compare mileages as illustrated in FIG. 3D, or may identify information included in the standard OBD data and compare data corresponding to various parameters, in addition to a method of recommending a vehicle according to a driving state.

FIG. 3E illustrates a UI operation displayed on a display unit of an electronic device according to an embodiment of the present invention.

Referring to FIG. 3E, the OBD check program 114 of the electronic device 100 determines and displays a vehicle state using a value of a predetermined item by using the standard OBD data. Also, when standard OBD data about two or more vehicles is included in the memory unit 110 of the electronic device 100, vehicle states of two or more vehicles may be displayed as illustrated in FIG. 3D.

For example, referring to the touchscreen 133 of FIG. 3E, items about the total driving distance, the average mileage, the engine state, the coolant state, and the transmission state of three vehicles (the vehicle #1, the vehicle #2, and the vehicle #3) may be displayed. Also, only items of a vehicle to be checked may be opened and checked, and the display of detailed items may be hidden as in the case of the vehicle #2 displayed on the touchscreen 133.

Referring to vehicle #1, information of the standard OBD data of the vehicle #1 is used to determine and display the total driving distance “71,945 Km”, the average mileage “11.74 Km/L”, the engine state “normal”, the coolant sate “check necessary”, and the transmission state “abnormal”. When the Detail button 321 of the coolant state is selected, detailed data about the coolant state of the vehicle #1 may be checked. When the Detail button 323 of the transmission state is selected, detailed data about the transmission state of the vehicle #1 may be checked. For example, when the Detail button 321 of the coolant state is selected, the “Detail” tab 303 is opened, “Vehicle #1” in the drop down menu 301 and “coolant” in the drop down menu 310 are automatically selected and displayed, and detailed data thereof may be checked. As another example, when the Detail button 323 of the transmission state is selected, the “Detail” tab 303 is opened, “Vehicle #1” in the drop down menu 301, and “Transmission” in the drop down menu 310 are automatically selected and displayed, and detailed data thereof may be checked.

Referring to vehicle #3, information of the standard OBD data of the vehicle #3 is used to determine and display the total driving distance “114,753 Km”, the average mileage “7.75 Km/L”, the engine state “normal”, the coolant sate “normal”, and the transmission state “check necessary”. When the Detail button 325 of the transmission state is selected, the “Detail” tab 303 is opened, “Vehicle #3” in the drop down menu 301, and “Transmission” in the drop down menu 310 are automatically selected and displayed, and detailed data thereof may be checked.

When “327” is selected, a setting menu capable of setting a UI environment of the OBD check program 114 may be used. For example, a vehicle to be used may be registered by using an identification code, a data format to be used among the OBD data and the standard OBD data may be registered, a vehicle name may be changed, and a target to be compared with the data selected in the “Comparison” tab 305 may be determined. In the case of the “Vehicle Management” tab 307, it is possible to provide a menu capable of selecting items to be displayed among the items capable of displaying information provided by the OBD data or the standard OBD data, such as, for example, the total driving distance, the average mileage, the engine state, the coolant state, and the transmission state.

FIG. 4A illustrates a program operation in an electronic device according to an embodiment of the present invention.

Referring to FIG. 4A, the electronic device 100 receives OBD data from the OBD device 201 and transmits the OBD data to the server 203. The electronic device 100 transmits OBD data to the server 203 and receives standard OBD data from the server 203 according to a predetermined format. The second electronic device (not illustrated) transmits OBD data to the server 203, and the electronic device 100 receives standard OBD data from the server 203 according to a predetermined format. The OBD device 201 transmits OBD data to the server 203, and the electronic device 100 receives standard OBD data from the server 203 according to a predetermined format. The electronic device 100 or the OBD check program 114 uses an appointed program language or an appointed UI environment associated with the server 203, and displays standard OBD data.

Hereinafter, an embodiment of an operation of the electronic device 100 will be described in detail.

In step 401, the electronic device 100 may receive OBD data from the OBD device 201 of the vehicle.

For example, the electronic device 100 receives EOBD data from the EOBD device of the vehicle #1 that is appointed to communicate OBD data.

The electronic device 100 and the EOBD device of the vehicle #1 may use an appointed identification code, and the devices may exchange data with each other. Data measured by the EOBD device of the vehicle #1 may be configured by using at least one of various protocols used by the OBD device such as CAN or PWM, and may include a vehicle identification code and a parameter ID code. The EOBD device of the vehicle #1 may transmit the EOBD data periodically or when connected to the electronic device 100.

In addition, when the electronic device 100 or the OBD check program 114 uses an instruction or a UI environment necessary to process the EOBD data received from the EOBD device and provides the EOBD standard, it may display information included in the received EOBD data. The electronic device 100 or the OBD check program 114 may not provide some of the configurations of the EOBD standard (which may include parameters, protocols, and instructions), and may fail to display at least a portion of the information included in the received EOBD data when at least one of the instruction and the UI environment is not used. The electronic device 100 or the OBD check program 114 may not provide some of the configurations of the EOBD standard, and may fail to display all of the information included in the received EOBD data when both of the instruction and the UI environment are not used.

In step 403, the electronic device 100 transmits OBD data to the server 203.

For example, the electronic device 100 may transmit the EOBD data received from the EOBD device of the vehicle #1 to the server 203 without displaying the same on the touchscreen 133 or the second display unit (not illustrated) by using the OBD check program 114 of the electronic device 100. The electronic device 100 and the server 203 may use an appointed identification code, and the devices may communication data with each other. The electronic device 100 may construct EOBD data including an identification code of the vehicle #1 or an identification code of the electronic device 100 and transmit the constructed EOBD data to the sever 203.

Steps 401 and 403 illustrate operations of the electronic device 100 for providing nonstandard OBD data acquired from the OBD of the vehicles according to an embodiment of the present invention. The nonstandard OBD data may be or may not be processed by the electronic device 100 according to the OBD standard format of the OBD device 201 programmed with the OBD data, or the OBD standard format provided by the OBD check program 114. The electronic device 100 may transmit nonstandard OBD data to the server 203, and the server 203 may standardize the OBD data received from the electronic device 100 according to a predetermined format.

Steps 405, 407 and 409 illustrate operations of the electronic device 100 for receiving standardized OBD data according to an embodiment of the present invention. The electronic device 100 may access the server 203 to receive standard OBD data, and the electronic device 100 or the OBD check program 114 may process and display the standard OBD data according to an appointed instruction or an appointed UI environment associated with the server 203, regardless of the OBD standard.

The dotted line between step 403 and step 405 means that a predetermined time may elapse between step 403 and step 405. That is, the electronic device 100 may connect to the server directly after performing step 403, may perform step 401 and step 403 until connection to the server at the request of a user, may check the OBD data or the standard OBD data included in the memory unit 110 of the electronic device 100 by using the OBD check program 114, and may perform an operation unrelated to the OBD check program 114. Herein, the operation unrelated to the OBD check program 114 may be performed after the electronic device 100 ends the connection with the OBD device or ends the OBD check program, and may be a multimedia service that may be provided by the electronic device 100.

In step 405, the electronic device 100 accesses the server 203 by using an appointed identification code.

For example, the server 203 may receive nonstandard EOBD data from the electronic device 100, may generate standard EOBD data according to a predetermined format by using an identification code, such as a vehicle identification code or an identification code of the electronic device 100 included in the EOBD data, and may construct a database thereof according to a predetermined format. The server 203 may identify the electronic device 100 connected to the server 203, by determining the connection of the electronic device 100 through an access code when the electronic device 100 attempts a connection to the server 203 by inputting an access code of the server 203 in the setting of the EOBD check program of the electronic device 100; by determining the connection of the electronic device 100 through an identification code when the electronic device 100 attempts a connection to the server 203 by registering (or storing) an identification code of the electronic device 100 in a database; or by determining the connection of the electronic device 100 through a vehicle identification code when the electronic device 100 attempts a connection to the server 203 by registering (or storing) an identification code of the vehicle, whose standard OBD data is to be received from the server 203, in the setting of the OBD check program 114 of the electronic device 100 or registering (or storing) the same in the database of the server 203. Also, the server 203 may use a general method to identify the electronic device 100 when the electronic device 203 connects to the server 203.

In step 407, the electronic device 100 selects and receives standard OBD data from the server 203.

For example, when the electronic device 100 connects to the server 203, the server 203 may transmit a list of communicatable standard EOBD data to the electronic device 100 by using an appointed identification code appointed with the electronic device 100, or may transmit the same to the electronic device 100 at the request of the electronic device 100. The electronic device 100 may receive all or some of data corresponding to the list of communicatable standard EOBD data. The electronic device 100 may periodically receive all or some of the data corresponding to the list of communicatable standard EOBD data.

Also, the electronic device 100 may receive not only the standard EOBD data, which is transmitted from the electronic device 100 to the server 203 and is standardized by the server 203, but also other standard OBD data of the server 203 by registering (setting) a vehicle identification code or an identification code of the electronic device 100 in the database of the server 203.

For example, the electronic device 100 may transmit the EOBD data, which is received from the vehicle #1 and includes an identification code of the vehicle #1 or an identification code of the electronic device 100, to the server 203, and receive the standard EOBD data of the vehicle #1 from the server 203. The KOBD device of the vehicle #2 may transmit KOBD data including an identification code of the vehicle #2 to the server 203; the second electronic device may receive the KOBD data from the KOBD device of the vehicle #2 and transmit the KOBD data including an identification code of the vehicle #2 or an identification code of the second electronic device to the server 203; and the server 203 may generate standard KOBD data of the vehicle #2 according to a predetermined format by using the KOBD data of the vehicle #2 and an identification code of the vehicle #2 or an identification code of the second electronic device.

The electronic device 100 may connect to the server 203 and receive the standard KOBD data of the vehicle #2 by acquiring the right to receive the standard KOBD data of the vehicle #2 by connecting to the server 203 and registering (setting) an identification code of the vehicle #2 or an identification code of the second electronic device; by acquiring the right to receive the standard KOBD data of the vehicle #2 by registering (setting) an identification code of the vehicle #2 an identification code of the second electronic device and an identification code of the electronic device 100 in the server 203; or by acquiring the right to receive the standard KOBD data of the vehicle #2 by connecting to the server 203 and registering (setting) an identification code of the vehicle #2 an identification code of the second electronic device and an identification code of the electronic device 100.

The dotted line between step 407 and step 409 means that a predetermined time may elapse between step 407 and step 409. That is, the electronic device 100 may check the received standard OBD data by the OBD check program 114 directly after performing step 407, may perform steps 401 and 403 or steps 405 or 407 without checking the standard OBD data, and may perform an operation unrelated to the OBD check program 114. Herein, the operation unrelated to the OBD check program 114 may be performed after the electronic device 100 ends the connection with the OBD device or ends the OBD check program, and may be a multimedia service that may be provided by the electronic device 100.

In step 409, the electronic device 100 displays the standard OBD data included in the memory unit 110 of the electronic device 100.

For example, the electronic device 100 may display the standard KOBD data of the vehicle #2, the standard EOBD data of the vehicle #1, or other standard OBD data, which is received from the server 203 and is stored in the memory unit 110. The standard KOBD data or the EOBD data generated by the server 203 may be generated by using an appointed program language or an appointed UI environment appointed with the OBD check program of the electronic device 100, and the standard KOBD data or the standard EOBD data may be displayed in the electronic device 100 by using an appointed program language or an appointed UI environment, regardless of the OBD standard used by the OBD check program 114.

Also, the electronic device 100 may compare and display standard OBD data corresponding to at least two vehicles.

For example, since the standard EOBD data of the vehicle #1 and the standard KOBD data of the vehicle #2 may use the same format, the electronic device 100 may compare values corresponding to a PID. The electronic device 100 or the server 203 including a database program (not illustrated) may provide a service of comparing parameters by using the data provided by the vehicle manufacturers and the standard OBD data included in the database, which may be provided by the server 203 or the OBD check program.

Referring to FIG. 3C, values corresponding to the periodical mileages of the vehicle #1, the vehicle #2, and the vehicle #3 may be displayed in a graph, and the average mileage may also be displayed. Also, when the item 302 is selected by “View in Chart”, values corresponding to the graph may be checked by a table.

As another example, a vehicle mileage may be itemized by each driving state. The itemized vehicle mileage may be compared with an itemized comparison group mileage and displayed, and a recommended vehicle for the driving state corresponding to each item may be displayed.

Referring to FIG. 3D, the mileage of each vehicle may be itemized into high constant speed driving, low constant speed driving, and congested driving according to the driving state. Referring to Vehicle #1 of FIG. 3D, item 363 represents mileage information of the same model A vehicle, which is the comparison group of the vehicle #1, by a value corresponding to each item, and item 365 represents mileage information of the vehicle #1 by a value corresponding to each item. Vehicle #2 or vehicle #3 may also represent mileage information of the same mode B or C vehicle, which is the comparison group, by a value corresponding to each item, and a recommended vehicle for each driving state may be displayed.

Referring to item 367 of FIG. 3D, the vehicle #3 may be recommended in a city-driving state corresponding to a congested-driving state, and the vehicle #2 may be recommended in a high speed driving state corresponding to a high constant speed driving state.

In addition to the mileage comparison between vehicles, information included in the standard OBD data may be compared by using an identification code such as a PID code, and a value of a comparison target may be represented in a graph or a table.

In embodiments of the present invention, data communication between the OBD device 201 and the electronic device 100, between the electronic device 100 and the server 203, and between second electronic device and the electronic device 100 may be performed in response a user's request, may be automatically performed at a predetermined date and time, may be automatically performed at a predetermined weekday or at a predetermined date of each month, may be automatically performed at predetermined periods such as time, day, month, and year, or may be performed when the above devices are connected.

FIG. 4B illustrates a program operation in an electronic device 100 according to an embodiment of the present invention.

In step 411, the electronic device 100 receives nonstandard OBD data from the OBD device 201 of the vehicle or the second electronic device. The operation of receiving the OBD data may be the same as step 401 of FIG. 4A.

For example, the electronic device 100 may receive OBD data from the OBD device of the vehicle that is appointed to communicate OBD data. Also, the electronic device 100 may receive OBD data from the second electronic device that is appointed to communicate OBD data. The OBD device may transmit the OBD data including an identification code for identifying the OBD device to the electronic device 100. When the OBD data transmitted from the second electronic device to the electronic device 100 is the OBD data received from a second OBD device, the OBD data may include an identification code of the second OBD device, and an identification code of the second electronic device may be included in the OBD data including the identification code of the second OBD device.

In step 413, the electronic device 100 constructs a database. The electronic device 100 may generate standard OBD data by using the OBD data, may compare the performances of at least two vehicles of the OBD data or devices included in the vehicle, and may construct a database by the standard OBD data, the identification code of the vehicle, the identification code of the vehicle, the identification code of the OBD device, and the identification code of the electronic device 100. That is, the electronic device 100 may be the server 203, and may include some or all of the functions of a database program included in the server 203.

For example, the database program may include the identification codes of vehicle #1, vehicle #2, and vehicle #3 in one group, may receive the OBD data of each vehicle, and may generate standard OBD data by the OBD data. The database program may obtain the mileage of each vehicle from the standard OBD data of the vehicle #1, the standard OBD data of the vehicle #2, and the standard OBD data of the vehicle #3 by an identification code such as a PID code. The mileage of each vehicle may be obtained by a detailed item according to a driving state such as high speed driving, low speed driving, or congested driving. Also, the database program may obtain and compare various performances of each vehicle or devices constituting the vehicle not only in the mileage comparison data of each vehicle but also in the standard OBD data by identification codes such as a functional identification code of the vehicle and a PID code, and may generate data comparing various performances of the vehicle or the devices constituting the vehicle. The database program may construct a database by using the comparison data and the standard OBD data of each vehicle.

In addition, the database program transmits data of the database to the second electronic device at the request of the second electronic device, which is capable of receiving data included in one group.

For example, the second electronic device may connect to the database of the electronic device 100 and receive the comparison data or the standard OBD data of vehicle #1, vehicle #2, and vehicle #3. The database program of the electronic device 100 may be accessed by the second electronic device and may transmit a list of data capable of transmission request to the second electronic device; and the second electronic device may request the electronic device 100 to transmit data such as the OBD data of the vehicle #1 to be received in the list of data and the mileage comparison data of the vehicle #2 and the vehicle #3. The electronic device 100 may transmit the data to the second electronic device; and the second electronic device may receive the data and display the received data.

The communication method between the electronic device 100 and the OBD device 201 of the vehicle and between the electronic device 100 and the server 203 may communicate data by using at least one of a communication system (not illustrated) of the OBD device 201 of the vehicle, the communication system 150 of the electronic device 100, a communication system (not illustrated) of the server 203, mobile communication through a base station, near-field communication, such as Infrared Data Association (IrDA), Bluetooth, or Wireless Fidelity (Wi-Fi), wireless LAN communication, and wired communication.

The methods according to the embodiments described in the claims or specification of the present invention may be implemented by hardware, software, or a combination thereof.

When the methods are implemented by software, a computer-readable storage medium may be provided to store one or more programs (software modules). The one or more programs stored in the computer-readable storage medium may be configured to be executed by one or more processors in the electronic device 100. The one or more programs may include instructions for causing the electronic device 100 to execute the methods according to the embodiments of the present invention.

These programs (software modules or software) may be stored in Random Access Memories (RAMs), nonvolatile memories including flash memories, Read Only Memories (ROMs), Electrically Erasable Programmable ROMs (EEPROMs), magnetic disc storage devices, Compact Disk-ROMs (CD-ROMs), Digital Versatile Disks (DVDs), other types of optical storage devices, or magnetic cassettes. Also, the programs may be stored in a memory configured by a combination of some or all of them.

Also, the programs may be stored in an attachable storage device that may be accessed by the electronic device 100 through a communication network such as Internet, Intranet, Local Area Network (LAN), Wireless LAN (WLAN), or Storage Area Network (SAN), or through a communication network configured by a combination thereof. This storage device may be accessed by the electronic device 100 through an external port.

Also, a separate storage device on a communication network may be accessed by the electronic device 100.

While the invention has been shown and described with reference to certain embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method for processing data in an electronic device, comprising the steps of:
receiving driving data, corresponding to a vehicle, from a driving data acquiring device;
transmitting the driving data to a server; and
receiving standard driving data, which is obtained by standardizing the driving data, from the server,
wherein the standard driving data is compared with second standard driving data, other vehicle driving data, or other vehicle standard driving data.

2. The method of claim 1, wherein the reception or the transmission is performed by at least one of mobile communication, Infrared Data Association (IrDA), Wireless Fidelity (Wi-Fi), and Near Field Communication (NFC).

3. The method of claim 1, wherein at least one of receiving the driving data from the driving data acquiring device, transmitting the driving data to the server, and receiving the standard driving data from the server comprises an operation performed when a predetermined reference condition in the driving data acquiring device or the electronic device is satisfied,
wherein the predetermined reference condition includes at least one of:
a case in which the driving data acquiring device and the electronic device are connected to each other;
a case in which the time of the electronic device reaches a reference weekday and a reference time;
a case in which the time of the electronic device reaches a reference day and a second reference time;
a case in which the time of the electronic device reaches a reference month, a second reference day, and a third reference time; and
a case in which the time of the electronic device reaches a reference year, a second reference month, a third reference day, and a fourth reference time.

4. The method of claim 1, further comprising:
displaying the standard driving data by the electronic device.

5. The method of claim 4, further comprising:
displaying a parameter of the vehicle, which is to be checked, or a parameter value corresponding to the parameter, by a Diagnostic Trouble Code (DTC) of the standard driving data.

6. The method of claim 4, further comprising:
displaying a mileage comparison between the standard driving data of the vehicle and the second standard driving data of the vehicle, the other vehicle driving data, or the other vehicle standard driving data.

7. The method of claim 6, wherein the mileage comparison includes comparing at least two mileages corresponding to at least two of driving states including high-speed driving, low-speed driving, congested driving, and average driving, and
wherein the mileages are obtained from parameter values corresponding to at least two parameters among intake air temperature, average molecular weight of air, fuel constant, volumetric efficiency, engine exhaust amount, engine Revolutions Per Minute (RPM), fuel injection amount, and fuel injection time included in the standard driving data.

8. The method of claim 7, further comprising:
displaying the ranking of the at least two mileages corresponding to the at least two of the driving states including high-speed driving, low-speed driving, congested driving, and average driving.

9. A method for processing data in an electronic device, the method comprising the steps of:
receiving driving data, corresponding to a vehicle, from a driving data acquiring device or a second electronic device;
generating standard driving data using the driving data;
constructing a database of the driving data or the standard driving data by the electronic device; and
transmitting the standard driving data to the second electronic device in response to a request by the second electronic device.

10. The method of claim 9, wherein the standard driving data is compared with second standard driving data or other vehicle driving data.

11. An electronic device comprising:
at least one processor;
at least one communication system configured to communicate with a driving data acquiring device or a server;
at least one memory unit; and
at least one program stored in the at least one memory unit and executed by the at least one processor,
wherein the at least one program comprises at least one instruction for:
receiving driving data, corresponding to a vehicle, from the driving data acquiring device;
transmitting the driving data to the server;
receiving standard driving data, which is obtained by standardizing the driving data, from the server; and
displaying information regarding the standard driving data.

12. The electronic device of claim 11, wherein the at least one program uses at least one of mobile communication, Infrared Data Association (IrDA), Wireless Fidelity (Wi-Fi), and Near Field Communication (NFC).

13. The electronic device of claim 11, wherein the at least one program performs a method including receiving the driving data from the driving data acquiring device, transmitting the driving data to the server, and/or receiving the standard driving data from the server when a predetermined reference condition in the driving data acquiring device or the electronic device is satisfied, and
wherein the reference condition comprises at least one of:
a case in which the driving data acquiring device and the electronic device are connected to each other;
a case in which the time of the electronic device reaches a reference weekday and a reference time;
a case in which the time of the electronic device reaches a reference day and a second reference time;
a case in which the time of the electronic device reaches a reference month, a second reference day, and a third reference time; and
a case in which the time of the electronic device reaches a reference year, a second reference month, a third reference day, and a fourth reference time.

14. The electronic device of claim 11, wherein the at least one program further comprises an instruction for displaying a parameter of the vehicle, which is to be checked, or a parameter value corresponding to the parameter, by a Diagnostic Trouble Code (DTC) of the standard driving data.

15. The electronic device of claim 11, wherein the at least one program further comprises an instruction for displaying a mileage comparison between the standard driving data of the vehicle and the second standard driving data of the vehicle, the other vehicle driving data, or the other vehicle standard driving data.

16. The electronic device of claim 15, wherein the at least one program further comprises an instruction for comparing at least two mileages corresponding to at least two of driving states including high-speed driving, low-speed driving, congested driving, and average driving, and
wherein the mileages are obtained from parameter values corresponding to at least two parameters among intake air temperature, average molecular weight of air, fuel constant, volumetric efficiency, engine exhaust amount, engine revolutions per minute (RPM), fuel injection amount, and fuel injection time included in the standard driving data.

17. The electronic device of claim 16, wherein the at least one program further comprises an instruction for displaying the ranking of the at least two mileages corresponding to the at least two of the driving states including high-speed driving, low-speed driving, congested driving, and average driving.

18. An electronic device comprising:
at least one processor;
at least one communication system configured to communicate with a driving data acquiring device or a second electronic device;
at least one memory unit; and
at least one program stored in the at least one memory unit and executed by the at least one processor,
wherein the at least one program comprises at least one instruction for:
receiving driving data, corresponding to a vehicle, from the driving data acquiring device or the second electronic device;
generating standard driving data using the driving data;
constructing a database of the driving data or the standard driving data by the electronic device; and
transmitting the standard driving data to the second electronic device in response to a request by the second electronic device.

19. The electronic device of claim 18, wherein the at least one program further comprises an instruction for comparing the standard driving data with second standard driving data or other vehicle driving data.

20. A method for processing data in an electronic device, the method comprising the steps of:
receiving driving data, corresponding to a vehicle, from a driving data acquiring device or a second electronic device;
generating standard driving data using the driving data;
constructing a database of the driving data or the standard driving data by the electronic device;
displaying information regarding the standard driving data included in the database; and
transmitting the standard driving data to the second electronic device in response to a request by the second electronic device,
wherein the standard driving data is compared with second standard driving data, other vehicle driving data, or other vehicle standard driving data.
